(19) United States
(12) Patent Application Publication
(10) Pub. No.: US 2015/0253944 A1
(43) Pub. Date: Sep. 10, 2015

(54) METHOD AND APPARATUS FOR DATA PROCESSING

(71) Applicant: Tencent Technology (Shenzhen) Company Limited, Shenzhen (CN)

(72) Inventors: Qi FAN, Shenzhen (CN); Hongrui Tang, Shenzhen (CN)

(21) Appl. No.: 14/720,611

(22) Filed: May 22, 2015

Related U.S. Application Data
(63) Continuation of application No. PCT/CN2013/085025, filed on Oct. 11, 2013.

(30) Foreign Application Priority Data
Nov. 26, 2012 (CN) 201210487073.9

(51) Int. Cl. G06F 3/0483; G06F 3/0488

(52) U.S. Cl. CPC G06F 3/0483; G06F 3/0488

(57) ABSTRACT

The present disclosure provides a data display page processing method and an associated mobile terminal. The method includes: detecting a touch signal on the touchscreen; displacing the data display page on the touchscreen in accordance with the touch signal; determining whether the data display page is a last page of a data set when the data display page is displaced; and performing data set exit process when the data display page is the last page of the data set and the displacement of the data display page is greater than a first preset value.

### RELATED APPLICATIONS

This application is a continuation application of PCT Patent Application No. PCT/CN2013/085025, entitled “METHOD AND APPARATUS FOR DATA PROCESSING” filed on Oct. 11, 2013, which claims priority to Chinese Patent Application No. 201210487073.9, filed with the Chinese Patent Office on Nov. 26, 2012 and entitled “METHOD AND APPARATUS FOR DATA PROCESSING”, both of which are incorporated by reference in their entirety.

### FIELD OF THE TECHNOLOGY

This application relates to the field of terminal technologies, and in particular, to a data processing method and an associated mobile terminal.

### BACKGROUND OF THE DISCLOSURE

Currently, touchscreen technologies have been widely applied to various electronic devices. For ease of operation, a mouse or keyboard is replaced with a touchscreen. Generally, an operation on a mobile terminal is performed by touching, by a finger, a touchscreen. Mobile terminal having a touchscreens are wide in application and various in type, for example, a touchscreen mobile phone, a tablet computer, and the like are very common in life.

Generally, a mobile terminal is capable of browsing pictures, texts, webpages, and the like. As shown in FIG. 1, a browsing interface is provided. The browsing interface includes browsed content, a return option and a close option at corners of the browsing interface, and the like. Generally, because the screen size of a mobile terminal is limited, not all browsed content can be displayed, for example, browsed content is a picture set including multiple pictures, a browsing interface can only display one picture at a time. In a process of browsing, when the mobile terminal learns that a picture on a browsing interface is clicked and a distance by which the picture is dragged is greater than a preset distance, the picture in the picture set is switched to a next picture. After a last picture in the picture set is displayed, the picture set is closed and the browsing interface is returned to a previous menu after a return option is activated, or the picture set is closed and the browsing interface is directly returned to a main screen after a close option is activated.

In a process of implementing the present disclosure, the inventor finds that the conventional technology at least has the following problem:

In the conventional technology, a manner of exiting browsed content needs to switch from a sliding program of browsing to an exit program, so as to exit browsed content, and therefore the exit process is relatively tedious.

### SUMMARY

The present disclosure provides a data processing method and an associated mobile terminal, which enable a data set to exit conveniently and quickly.

To achieve the foregoing objective, the following technical solutions are used in the present disclosure:

According to an aspect of the present disclosure, a data processing method includes:

detecting a touch signal on the touchscreen;

displacing the data display page on the touchscreen in accordance with the touch signal;

determining whether the data display page is a last page of a data set when the data display page is displaced; and

performing data set exit process when the data display page is the last page of the data set and the displacement of the data display page is greater than a first preset value.

In another embodiment, the data set exit process may include: displaying partial content of the last page in accordance with the touch signal when the displacement of the data display page is less than or equal to the first preset value.

According to another aspect, a mobile terminal includes a touchscreen; one or more processors; memory; and a plurality of program units stored in the memory and to be executed by the one or more processors, the program units further including:

a first determining unit, configured to detect a touch signal on the touchscreen, displace the data display page on the touchscreen in accordance with the touch signal, and determine whether the data display page is a last page of a data set when the data display page is displaced; and

an exit processing unit, configured to perform data set exit process when the data display page is the last page of the data set and the displacement of the data display page is greater than a first preset value.

According to the data processing method and associated mobile terminal provided in the present disclosure, because when a data display page is displaced and the data display page is a last page of the data set, the data set is hidden from the touchscreen, or when the data display page is not a last page of the data set and a touch start point is located within an exit area, the data set is hidden from the touchscreen. In the present disclosure, when browsing a data set, the data set can be closed by removing a data display page. However, in the conventional technology, when a data set is closed, switching needs to be performed from a sliding program of browsing to an exit program, that is, a return option or an exit option needs to be clicked to close the data set, and therefore the exit process is relatively tedious. Therefore, the present disclosure enables a data set to exit conveniently and quickly.

### BRIEF DESCRIPTION OF THE DRAWINGS

To illustrate the technical solutions in the embodiments of the present disclosure or in the conventional technology more clearly, the following briefly introduces the accompanying drawings required for describing the embodiments or the conventional technology. Apparently, the accompanying drawings in the following description show merely some embodiments of the present disclosure, and persons of ordinary skill in the art may still derive other drawings from these accompanying drawings without creative efforts.

FIG. 1 is a schematic diagram of a browsing interface of a mobile terminal of the conventional technology;

FIG. 2 is a flowchart of a data processing method provided in an embodiment of the present disclosure;

FIG. 3 is a flowchart of a data processing method provided in another embodiment of the present disclosure;

FIG. 4 is a flowchart of a data processing method provided in another embodiment of the present disclosure;

FIG. 5 is a schematic diagram of a browsing interface of a mobile terminal in an embodiment of the present disclosure;

FIG. 6 is a schematic structural diagram of a data processing apparatus provided in an embodiment of the present disclosure; and

FIG. 7 is a schematic structural diagram of a data processing apparatus provided in another embodiment of the present disclosure.

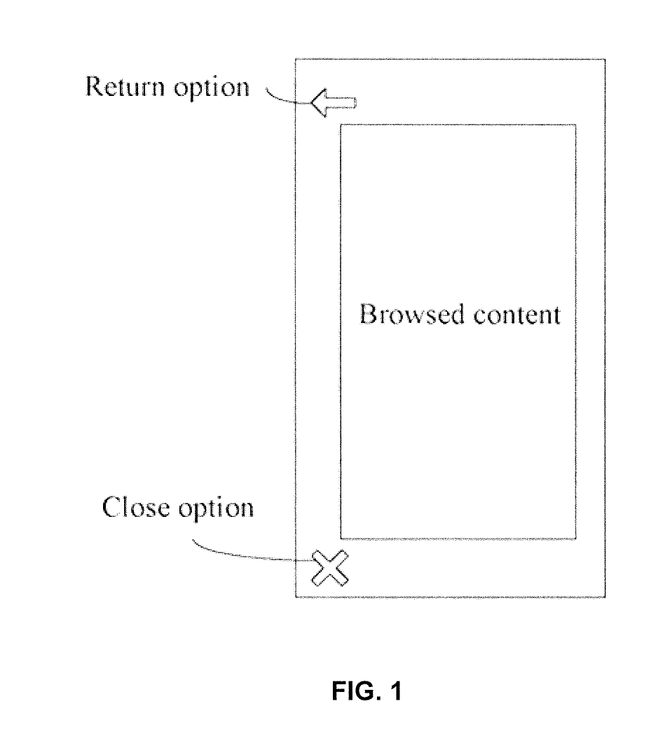

### DESCRIPTION OF EMBODIMENTS

The following describes technical solutions in embodiments of the present disclosure clearly and completely with reference to the accompanying drawings. Apparently, the described embodiments are only some of the embodiments of the present disclosure rather than all of the embodiments. All other embodiments obtained by a person of ordinary skill in the art based on the embodiments of this application without creative efforts shall fall within the protection scope of this application.

To make advantages of the technical solutions of this application clearer, the following describes the present disclosure in detail with reference to the accompanying drawings and embodiments.

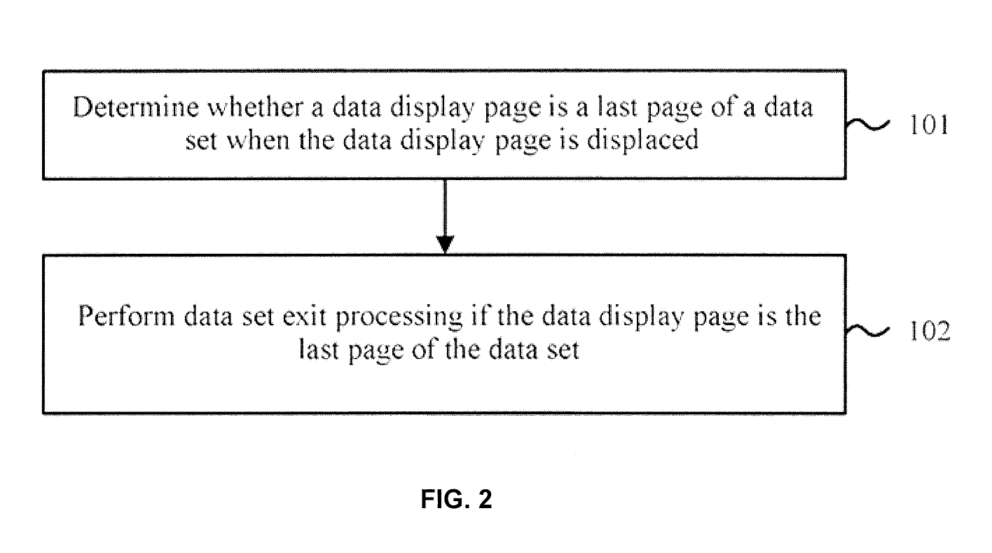

FIG. 2 is a flowchart of a data processing method 100 performed at a mobile terminal having a touchscreen provided in an embodiment of the present disclosure. As shown in FIG. 2, the method 100 includes: step 101 of determining whether a data display page is a last page of a data set when the data display page is displaced; and step 102 of performing data set exit process when the data display page is the last page of the data set. In some embodiments, step 101 further includes detecting a touch signal on the touchscreen and displacing the data display page on the touchscreen in accordance with the touch signal.

In an embodiment, the data set exit process may include: hiding the data set from the touchscreen. However, in another embodiment, the data set exit process may include: determining whether a touch start point enabling the data display page to be displaced is located within an exit area of a screen of a mobile terminal, so as to determine whether to exit the data set. Certainly, the data set exit process is not limited thereto and may further include: hiding the data set from the touchscreen after the last page is displayed for a preset time. It should be clear that the “data set exit process” described herein not only refers to processing of exiting a data set, but also includes all processing performed for determining whether to exit a data set.

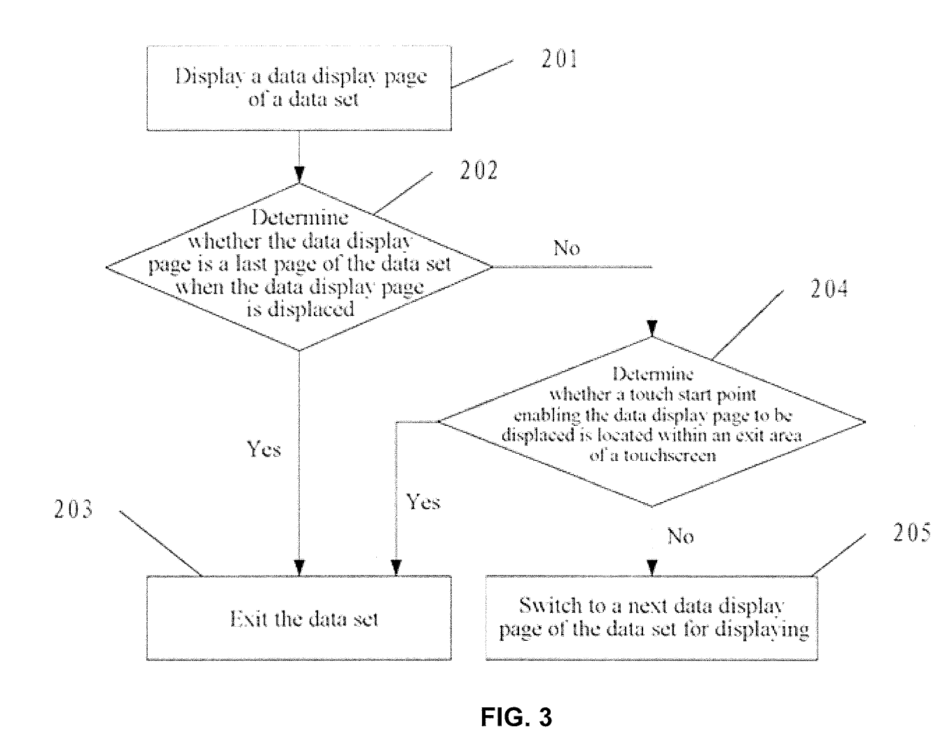

FIG. 3 is a flowchart of a data processing method 200 provided in another embodiment of the present disclosure. As shown in FIG. 3, the method 200 includes the following steps:

Step 201: Display a data display page of a data set.

In some embodiments, the data set is a picture media library and the data display page is a picture in the picture media library; or, in another embodiment, the data set is a text media library and the data display page is a text page in the text media library. However, examples of a data set and a data display page are not limited thereto.

Step 202: Determine whether the data display page is a last page of the data set when the data display page is displaced. Step 203 is performed if the data display page is the last page of the data set, or step 204 is performed when the data display page is not the last page of the data set.

In an embodiment, displacement of the data display page may be formed by dragging, by a user by clicking, the data display page. Certainly, reasons for causing a data display page to be displaced are not limited thereto.

Step 203: Hide the data set from the touchscreen.

In an embodiment, the step of hiding the data set from the touchscreen may include, but is not limited to, returning to a desktop (a main interface) of a mobile terminal, or returning to a selection interface of a data set.

Step 204: Determine whether a touch start point enabling the data display page to be displaced is located within an exit area of the touchscreen. Step 203 is performed when the touch start point is located within the exit area, or step 205 is performed when the touch start point is located out of the exit area.

For example, a touchscreen may be preset with an exit area. In an embodiment, the exit area is located at one side of four sides of the touchscreen and the size of the exit area may be predetermined, for example, depending on the size of a touchscreen. However, the location and size of an exit area are not limited thereto. A person of skill in the art may set the location and size of the exit area according to specific use situations.

Step 205: Switch to a next data display page of the data set for displaying.

Based on this, according to the data processing method provided in the foregoing embodiment of the present disclosure, when the data display page is displaced, if the data display page is the last page of the data set, data set exit process is performed. In the foregoing embodiment, the data set exit process may include: hiding the data set from the touchscreen.

In another aspect, when the data display page is not the last page of the data set, it is further determined whether the touch start point is located within the exit area, and based on a determining result, it is determined whether to exit the data set. In the foregoing embodiment, when the touch start point is located within the exit area, the data set is hidden from the touchscreen; or when the touch start point is located out of the exit area, a next data display page of the data set is switched to for displaying.

Therefore, according to the foregoing method of the present disclosure, when browsing a data set, the data set can be closed (hidden) by removing a data display page. However, in the conventional technology, when a data set is closed, switching needs to be performed from a sliding program of browsing to an exit program, that is, a return option or an exit option needs to be clicked to close the data set, and therefore the exit process is relatively tedious. Therefore, the method in the present disclosure enables a data set to exit conveniently and quickly.

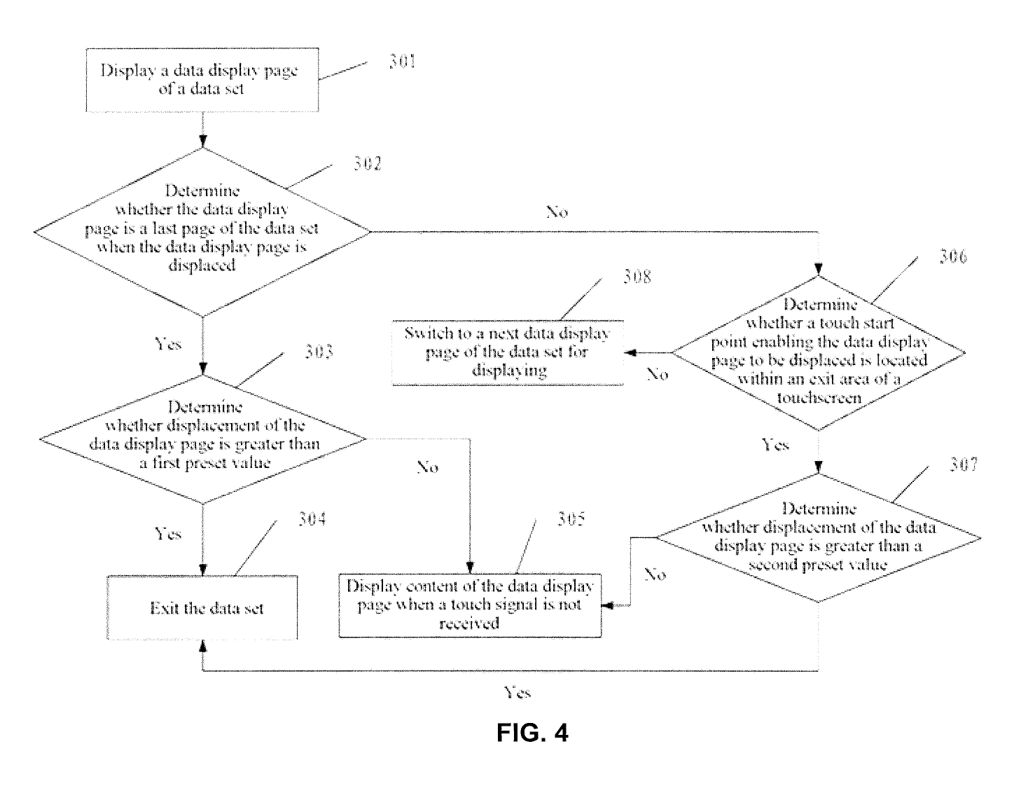

FIG. 4 is a flowchart of a data processing method 300 provided in another embodiment of the present disclosure. As shown in FIG. 4, the method 300 includes the following steps:

Step 301: Display a data display page of a data set.

In an embodiment, the data set is a picture media library and the data display page is a picture in the picture media library. Alternatively, in another embodiment, the data set is a text media library and the data display page is a text page in the text media library. However, examples of a data set and a data display page are not limited thereto.

Step 302: Determine whether the data display page is a last page of the data set when the data display page is displaced. Step 303 is performed if the data display page is the last page of the data set, or step 306 is performed when the data display page is not the last page of the data set.

Step 303: Determine whether displacement of the data display page is greater than a first preset value. Step 304 is performed if the displacement of the data display page is greater than the first preset value, or step 305 is performed if the displacement of the data display page is less than or equal to the first preset value.

In an embodiment, the first preset value may be, but is not limited to being, preset according to the size of a screen of a mobile terminal. A person of skill in the art may set the first preset value according to specific use situations.

Step 304: Hide the data set from the touchscreen.

In an embodiment, the step of hiding the data set from the touchscreen may include, but is not limited to, returning to a desktop (a main interface) of a mobile terminal, or returning to a selection interface of a data set.

Step 305: Display content of the data display page when a touch signal is not received.

In an embodiment, the touch signal is a constant signal when a user drags the data display page, and after the user releases the data display page, a mobile terminal cannot receive the touch signal, so that the mobile terminal continues to display content of the current data display page.

Step 306: Determine whether a touch start point enabling the data display page to be displaced is located within an exit area of the touchscreen. Step 307 is performed if the touch start point enabling the data display page to be displaced is located within the exit area of the touchscreen, or step 308 is performed if the touch start point enabling the data display page to be displaced is located out of the exit area of the touchscreen but is located within a regular switch area of the touchscreen.

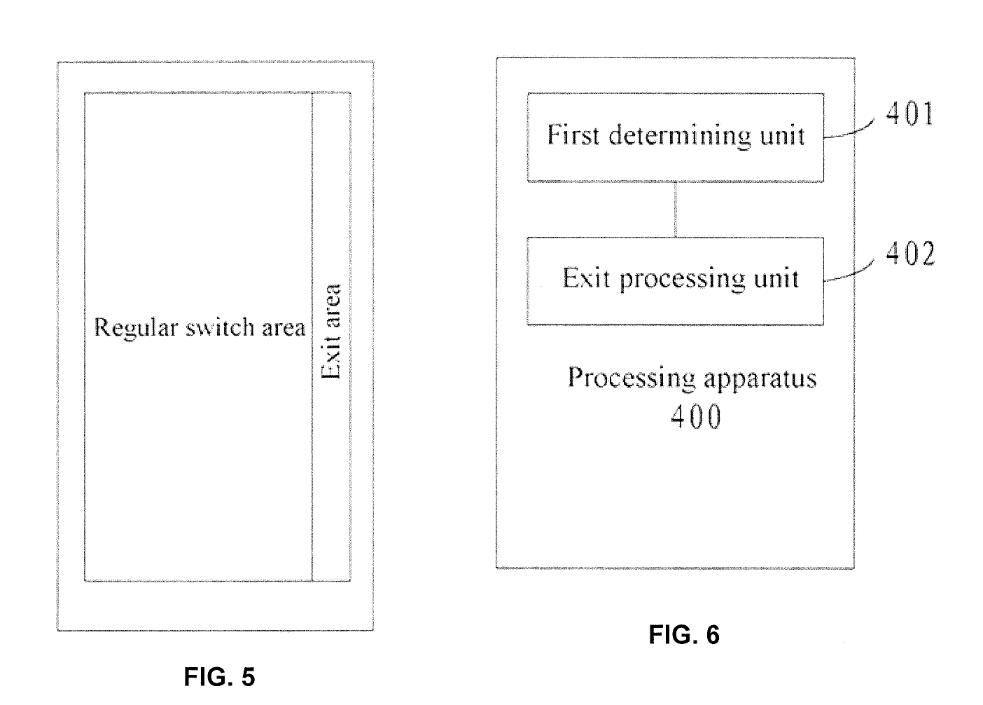

FIG. 5 shows an example of a touchscreen applicable to the present disclosure. As shown in FIG. 5, the touchscreen may be divided into a regular switch area and an exit area. When the touch start point is located within the regular switch area and is displaced, the data display page is switched to a next data display page of the data set; and when the touch start point is located within the exit area and is displaced, the data set may be exited, but the present disclosure is not limited thereto. As stated above, the location and size of an exit area may be predetermined based on a touchscreen. In an embodiment, the exit area may be located at one side of four sides of the touchscreen, for example, normally, if a picture set is browsed in a sliding manner from right to left, the exit area may be, but is not limited to being, located at the boundary of the right side of the touchscreen.

In addition, as shown in FIG. 5, when it is determined that the touch start point is located within the exit area, optionally, exit prompt information may be displayed in the exit area.

For example, the exit prompt information may be used for providing a user with a prompt that the user is clicking the exit area, and after the exit area is dragged and displaced, the data set is hidden from the touchscreen. For example, the exit prompt information may be similar information such as “continuing to slide to exit”, but the exit prompt information is not merely limited thereto.

Step 307: Determine whether the displacement of the data display page is greater than a second preset value. Step 305 is performed if the displacement of the data display page is less than or equal to the second preset value, or step 304 is performed if the displacement of the data display page is greater than the second preset value.

Similar to the first preset value, the second preset value may be, but is not merely limited to being, preset according to the size of a touchscreen.

Step 308: Switch to a next data display page of the data set for displaying.

For example, in a picture media library, a touchscreen displays a picture in the picture media library, and when a touch start point is located within a regular switch area of a touchscreen and is dragged and displaced, the screen of a mobile terminal switches to a next picture for displaying.

Based on this, according to the data processing method provided in the present disclosure, when a data display page is displaced, if the data display page is a last page of the data set, data set exit process is performed. In the foregoing embodiment, the data set exit process may include: determining whether displacement of the data display page is greater than a first preset value; and displaying content of the last page when the displacement of the data display page is less than or equal to the first preset value and a touch signal is not received; or hiding the data set from the touchscreen when the displacement of the data display page is greater than the first preset value.

In another aspect, when the data display page is not a last page of the data set, it is further determined whether a touch start point enabling the data display page to be displaced is located within an exit area of a screen of a mobile terminal, and based on a determining result, it is determined whether to exit the data set.

Therefore, according to the method of the present disclosure, when browsing a data set, the data set can be closed by removing a data display page, so that it is not required to switch from a sliding program of browsing to an exit program, that is, it is not required to click a return option or an exit option to close a data set. Therefore, according to the method in the present disclosure, a data set can be exited conveniently and quickly.

FIG. 6 is a schematic structural diagram of a data processing apparatus 400 in an embodiment of the present disclosure. As shown in FIG. 6, the processing apparatus 400 includes a first determining unit 401 and an exit processing unit 402.

The first determining unit 401 is configured to determine whether a data display page is a last page of a data set when the data display page is displaced. For a specific implementation manner of the first determining unit, reference is made to step 101 shown in FIG. 2, which is not described herein again.

The exit processing unit 402 is configured to perform data set exit process when the first determining unit 401 determines that the data display page is the last page of the data set. In an embodiment, when the first determining unit determines that the data display page is the last page of the data set, the exit processing unit may perform the data set exit process, so as to exit the data set, and for a specific implementation manner of the exit processing unit, reference is made to step 203 shown in FIG. 3, which is not described herein again.

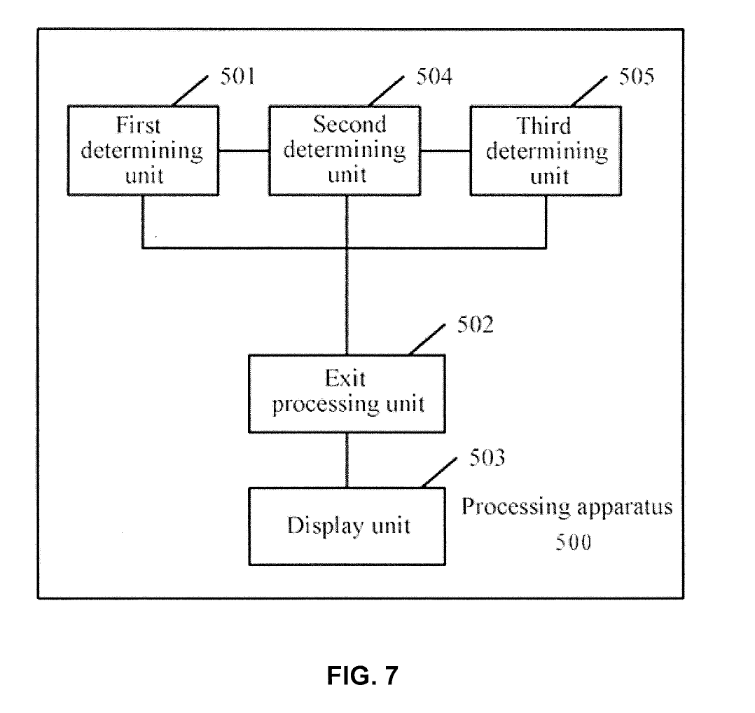

FIG. 7 is a schematic structural diagram of a data processing apparatus 500 according to another embodiment of the present disclosure. As shown in FIG. 7, the processing apparatus 500 includes a first determining unit 501 and an exit processing unit 502 that are generally the same as the first determining unit 401 and the exit processing unit 402 of the foregoing processing apparatus 400. Besides, the processing apparatus 500 may further include a display unit 503, a second determining unit 504, and a third determining unit 505.

The display unit 503 is configured to display data display pages in the data set.

The second determining unit 504 is configured to determine whether a touch start point enabling the data display page to be displaced is located within an exit area of the touchscreen if the first determining unit 501 determines that the data display page is not the last page of the data set. For a specific implementation manner of the second determining unit, reference is made to step 204 shown in FIG. 3, which is not described herein again.

In an embodiment, when the second determining unit 504 determines that the touch start point is located within the exit area, the exit processing unit 502 may enable the display unit 503 to exit display of the data set. For a specific implementation manner of the exit processing unit, reference is made to step 203 shown in FIG. 3, which is not described herein again.

In an embodiment, when the second determining unit 504 determines that the touch start point is located out of the exit area, the display unit 503 may switch to a next data display page of the data set for displaying.

The third determining unit 505 is configured to determine whether displacement of the data display page is greater than a first preset value. For a specific implementation manner of the third determining unit, reference is made to step 303 shown in FIG. 4, which is not described herein again.

In an embodiment, when the third determining unit 505 determines that the displacement of the data display page is less than or equal to the first preset value and a touch signal is not received, the display unit 503 may display content of the last page. For a specific implementation manner of the display unit, reference is made to step 305 shown in FIG. 4, which is not described herein again.

In an embodiment, the exit processing unit 502 may enable the display unit to hide the data set from the touchscreen when the third determining unit 505 determines that the displacement of the data display page is greater than the first preset value. For a specific implementation manner of the exit processing unit, reference is made to step 304 shown in FIG. 4, which is not described herein again.

In an embodiment, the third determining unit 505 may further determine whether the displacement of the data display page is greater than a second preset value. For a specific implementation manner of the third determining unit, reference is made to step 307 shown in FIG. 4, which is not described herein again.

In an embodiment, when the third determining unit 505 determines that the displacement of the data display page is less than or equal to the second preset value and a touch signal is not received, the display unit 503 may display content of the data display page. For a specific implementation manner of the display unit, reference is made to step 205 shown in FIG. 3, which is not described herein again.

In an embodiment, when the third determining unit 505 determines that the displacement of the data display page is greater than the second preset value, the exit processing unit 502 may enable the display unit 503 to exit display of the data set. For a specific implementation manner of the exit processing unit, reference is made to step 304 shown in FIG. 4, which is not described herein again.

In an embodiment, optionally, when the second determining unit 503 determines that the touch start point is located within the exit area, the display unit 503 may further display exit prompt information in the exit area.

For example, an example of the processing apparatus 400 or 500 may include a mobile terminal, and a touchscreen may be a screen of the mobile terminal, for example, the touchscreen shown in FIG. 5. Certainly, the processing apparatus 400 or 500 is not limited thereto. It should be noted that, to simplify the description of the present disclosure, other components of the processing apparatus 400 or 500 are not shown in FIG. 6 or FIG. 7 and descriptions of the components are omitted herein.

According to the foregoing data processing apparatus, when a data display page is displaced, a first determining unit determines whether the data display page is a last page of a data set, and if the data display page is the last page of the data set, an exit processing unit performs data set exit process. In an embodiment, the data set exit process performed by the exit processing unit may include: enabling the data set to be exited. In another embodiment, when the first determining unit determines that the data display page is the last page of the data set, it is determined whether displacement of the data display page is greater than a first preset value, and when the displacement of the data display page is greater than the first preset value, the exit processing unit enables the data set to be exited.

In another aspect, when a first determining unit determines that the data display page is not the last page of the data set, a second determining unit determines whether a touch start point enabling the data display page to be displaced is located within an exit area of the touchscreen, and when the second determining unit determines that the touch start point is located within the exit area, the exit processing unit enables the data set to be exited.

Therefore, when browsing a data set, a data set can be closed by removing a data display page, so that it is not required to switch from a sliding program of browsing to an exit program, that is, it is not required to click a return option or an exit option to close a data set. Therefore, according to the apparatus in the present disclosure, a data set can be exited conveniently and quickly.

Through descriptions of the foregoing implementation manners, it may be clearly understood by a person skilled in the art that, the technology in the present disclosure may be implemented by software and necessary universal hardware. Certainly, the technology in the present disclosure may be implemented by hardware, but the former is a preferred implementation manner in many situations. Based on such understanding, the technical solutions of the present disclosure essentially, or the part contributing to the conventional technology may be implemented in a form of a software product. The computer software product is stored in a readable storage medium, such as, a floppy disk, a hard disk, or an optical disc of a computer, and includes several instructions for instructing a computer device (which may be a personal computer, a server, a network device, or the like) to perform the methods described in the embodiments of the present disclosure.

The foregoing descriptions are merely specific implementation manners of the technologies of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the appended claims.

What is claimed is:

1. A data processing method, comprising:
at a mobile terminal having a touchscreen, one or more processors and memory for storing programs to be executed by the one or more processors:
detecting a touch signal on the touchscreen;
displacing the data display page on the touchscreen in accordance with the touch signal;
determining whether the data display page is a last page of a data set when the data display page is displaced; and
performing data set exit process when the data display page is the last page of the data set and the displacement of the data display page is greater than a first preset value.

2. The method according to claim 1, further comprising:
displaying partial content of the last page in accordance with the touch signal when the displacement of the data display page is less than or equal to the first preset value.

3. The method according to claim 1, further comprising:
determining whether a touch start point enabling the data display page to be displaced is located within an exit area of the touchscreen when the data display page is not the last page of the data set; and
hiding the data set from the touchscreen when the touch start point is located within the exit area.

4. The method according to claim 1, further comprising:
determining whether a touch start point enabling the data display page to be displaced is located within an exit area of the touchscreen when the data display page is not the last page of the data set;
determining whether the displacement of the data display page is greater than a second preset value when the touch start point is located within the exit area;
displaying content of the data display page when the displacement of the data display page is less than or equal to the second preset value and a touch signal is not received; and
hiding the data set from the touchscreen when the displacement of the data display page is greater than the second preset value.

5. The method according to claim 4, further comprising:
switching to a next data display page of the data set for displaying when the touch start point is located out of the exit area.

6. The method according to claim 4, further comprising:
displaying exit prompt information in the exit area when it is determined that the touch start point is located within the exit area.

7. The method according to claim 4, wherein the exit area is located at one side of four sides of the touchscreen.

8. The method according to claim 1, wherein the data set is a picture media library and the data display page is a picture in the picture media library.

9. A mobile terminal, comprising:
a touchscreen;
one or more processors;
memory; and
a plurality of program units stored in the memory and to be executed by the one or more processors, the program units further including:
a first determining unit, configured to detect a touch signal on the touchscreen, displace the data display page on the touchscreen in accordance with the touch signal, and determine whether the data display page is a last page of a data set when the data display page is displaced; and
an exit processing unit, configured to perform data set exit process when the data display page is the last page of the data set and the displacement of the data display page is greater than a first preset value.

10. The mobile terminal according to claim 9, wherein the program units further include:
a display unit, configured to display data display pages in the data set; and
a second determining unit, configured to determine whether a touch start point enabling the data display page to be displaced is located within an exit area of the touchscreen when the first determining unit determines that the data display page is not the last page of the data set, wherein the exit processing unit enables the display unit to hide the data set from the touchscreen when the second determining unit determines that the touch start point is located within the exit area.

11. The mobile terminal according to claim 10, wherein the display unit is configured to switch to a next data display page of the data set for displaying when the second determining unit determines that the touch start point is located out of the exit area.

12. The mobile terminal according to claim 10, wherein the display unit is configured to display partial content of the last page in accordance with the touch signal when the displacement of the data display page is less than or equal to the first preset value.

13. The apparatus according to claim 12, wherein the program units further include:
a third determining unit, configured to determine whether the displacement of the data display page is greater than a second preset value when the second determining unit determines that the touch start point is located within the exit area, wherein
the display unit is configured to display content of the data display page when the third determining unit determines that the displacement of the data display page is less than or equal to the second preset value and a touch signal is not received; and
the exit processing unit is configured to enable the display unit to hide the data set from the touchscreen when the third determining unit determines that the displacement of the data display page is greater than the second preset value. The apparatus according to claim 12, wherein the display unit is configured to display exit prompt information in the exit area when the second determining unit determines that the touch start point is located within the exit area.
